(19) United States
(12) Patent Application Publication
(10) Pub. No.: US 2024/0318804 A1
(43) Pub. Date: Sep. 26, 2024

(54) Device for Illuminating an Emblem or Lettering of a Motor Vehicle, and Illuminated Emblem or Lettering Therefor

(71) Applicant: Marelli Automotive Lighting Reutlingen (Germany) GmbH, Reutlingen (DE)

(72) Inventors: Martin Licht, Reutlingen (DE); Silvain Teysseyre, Reutlingen (DE)

(73) Assignee: Marelli Automotive Lighting Reutlingen (Germany) GmbH, Reutlingen (DE)

(21) Appl. No.: 18/613,607

(22) Filed: Mar. 22, 2024

(30) Foreign Application Priority Data
Mar. 24, 2023 (DE) 102023107545.4

(51) Int. Cl. F21S 43/20; F21S 43/14; F21S 43/31

(52) U.S. Cl. CPC F21S 43/26; F21S 43/14; F21S 43/31

(57) ABSTRACT

A device for illuminating an emblem or lettering of a motor vehicle arranged in a front region of the motor vehicle, including a semiconductor light source for emitting light in a main emission direction, wherein light leaving the device in a light emission direction is used to illuminate the emblem or lettering. The main emission direction of the semiconductor light source is oriented in the opposite direction to the light emission direction of the device. The semiconductor light source is overmolded or overpoured with a transparent material on its side encompassing the main emission direction, and a rear side of the transparent material opposite the semiconductor light source may be reflective. The reflective rear side deflects light emitted by the semiconductor light source in order to illuminate the emblem or lettering in the light emission direction.

### CROSS-REFERENCE TO RELATED APPLICATIONS

The present application claims priority to and all the benefits of German Patent Application No. 102023107545.4, filed on Mar. 24, 2023, the entire contents of which are hereby expressly incorporated herein by reference.

### BACKGROUND OF THE INVENTION

### 1. Field of the Invention

The present invention relates to a device for illuminating an emblem or lettering of a motor vehicle, wherein the emblem or lettering to be illuminated is preferably part of a front panel arranged in a front region of the motor vehicle. The device comprises a semiconductor light source for emitting light in a main emission direction, which serves to illuminate the emblem or the lettering.

The invention also relates to an illuminated emblem or illuminated lettering of a motor vehicle, preferably as part of a front panel arranged in a front region of the motor vehicle, comprising an illuminable emblem or illuminable lettering and a device with a semiconductor light source for illuminating the illuminable emblem or lettering.

Finally, the invention also relates to an arrangement comprising a front panel arranged in a front area of a motor vehicle with a plurality of illuminable emblems or lettering arranged next to and/or above one another and a plurality of devices each with a semiconductor light source for illuminating the emblems or lettering.

### 2. Description of the Related Art

In recent years, the night design of motor vehicles has evolved considerably. In addition to continuous light strips, which connect the headlights or rear lights with each other, illuminated emblems or lettering are also known in newer motor vehicles. For example, a backlit Mercedes star for the radiator grille has been available from Mercedes Benz Group AG for some time as an original retrofit part (item no. A1668177500). Furthermore, more recent concept vehicles from Mercedes Benz Group AG (e.g., Vision EQS), for example, have a front panel with a large number of backlit star-shaped emblems arranged above and/or next to one another.

Illuminated emblems or lettering are known from U.S. Pat. No. 7,712,933 B2 and DE 20 2016 105 622 U1 (corresponding to US 2017/0101047 A1), preferably as part of a front panel of a motor vehicle. An emblem can be a symbol, a logo or similar, preferably with reference to the vehicle manufacturer or the vehicle model. A lettering can be a name of the vehicle manufacturer, the vehicle model, an equipment variant, a single or several letters or similar. In the known illuminated emblems and lettering, light from a semiconductor light source, preferably an LED, is coupled into an optical body made of a solid transparent material on one side and decoupled again on the opposite side. Either the optical body itself has the shape of the emblem or lettering to be illuminated on its light emission side, or the optical body is covered on its light emission side by the emblem or lettering made of an opaque material. In the first case, the emblem or lettering itself is illuminated; in the second case, the areas of the light-emitting surface surrounding the emblem or lettering are illuminated so that the contour of the emblem or lettering is recognizable.

For the illumination of individual small light signatures, such as an emblem or lettering, in a front area of a motor vehicle, e.g., in a front panel, a low component thickness of the device for illuminating the emblem or lettering is desirable, particularly for reasons of pedestrian protection, when viewed in the direction of an optical axis of the device or a forward driving direction of the motor vehicle. At the same time, the emblem or lettering should be illuminated by the device as completely and homogeneously as possible, which means that additional measures must be taken to distribute and homogenize the light emitted in the main direction of radiation when using approximately point-shaped semiconductor light sources.

For an attractive appearance in daylight without illumination, the emblem or lettering to be illuminated usually has a metallic appearance. This is achieved by chrome-plating or reflecting the side of the emblem or lettering visible to the observer or parts of the visible side. If the emblem or lettering is to be illuminated, the chrome or mirror layer is partially transparent. However, the transmission is relatively low if an attractive chrome appearance is still to be achieved in the unlit state. The transmission is then usually between 1% and 20%. In this case, in order to achieve the necessary brightness of the illuminated emblem or lettering, a particularly efficient device for illumination (so-called light unit) is required, which still provides a sufficient level of brightness despite the low transmission.

A problem with the known devices for illuminating an emblem or lettering is the fact that inhomogeneities or even hotspots occur in the area of the semiconductor light sources, particularly with a flat structure (i.e., with a low component thickness in the direction of the optical axis of the device or in the direction of travel of the vehicle), as the relatively thin optical body does not provide a sufficient light path for homogenizing the light.

### SUMMARY OF THE INVENTION

Based on the described prior art, the present invention is therefore based on the object of providing a device for illuminating an emblem or lettering which, on the one hand, has a flat structure and, on the other hand, also ensures good homogenization of the light emitted by the device and used to illuminate the emblem or lettering.

This object is solved by a device for illuminating an emblem or lettering of a motor vehicle comprising a semiconductor light source for mounting in the device that is designed in such a way that the main emission direction of the semiconductor light source is aligned in the opposite direction to the light emission direction of the device, the semiconductor light source is overmolded or overpoured with a transparent material on its side encompassing the main emission direction, and a rear side of the transparent material opposite the semiconductor light source is designed to be reflective, wherein the reflective rear side is configured to deflect light emitted by the semiconductor light source into the light emission direction in order to illuminate the emblem or the lettering.

Consequently, the semiconductor light source is arranged and aligned in the device in such a way that its main direction of emission is directed away from the emblem or lettering to be illuminated when the device is mounted. The transparent material forms the light body for homogenizing the emitted light. It is not essential that the main direction of emission is exactly opposite to the direction in which the light is emitted; it is also conceivable that it could run at an angle to each other. It is sufficient if the deflection of the light emitted by the semiconductor light source in the direction of the light exit direction results in an extension of the light path through the optical body and thus improved homogenization of the emitted light.

Light emitted by the semiconductor light source is coupled into the transparent material or the optical body and propagates through it to the reflecting rear side. The light is then reflected at the rear side and leaves the optical body again via the front side of the transparent material that surrounds the semiconductor light source. This means that the light has ideally passed through the transparent material or the optical body twice on its way through the fixture. The light coupling surface and the light decoupling surface of the optical body are preferably formed by different areas of one and the same surface. The light coupling surface and the light decoupling surface are both arranged opposite the reflective rear side.

In one embodiment, the semiconductor light source is a light emitting diode (LED), and in particular, may be a so-called top emitting LED. Of course, the semiconductor light source could also be designed as an OLED or as a laser diode or comprise one of these. It would also be conceivable for the device to comprise more than one semiconductor light source. In one embodiment, the semiconductor light sources have white housings.

The transparent material may include a clear plastic material, such as polycarbonate (PC), polymethyl methacrylate (PMMA) or another suitable transparent plastic. The transparent material could also be a synthetic resin or the like.

The present invention enables a particularly thin or flat structure of the device for illuminating an emblem or lettering, which is technically particularly simple and yet provides good homogeneity of the emitted light.

One aspect of the invention consists in overmolding the semiconductor light source with the transparent material in an orientation in which the main emission direction of the semiconductor light source is directed away from the emblem or lettering to be illuminated. The main emission direction of the semiconductor light source therefore runs approximately opposite to the direction in which light leaves the device for illuminating the emblem or lettering. An optical axis of the device preferably runs congruently with the main emission direction of the semiconductor light source and the light exit direction of the device.

The outer surface or rear side of the transparent material or optical body, which is illuminated by the semiconductor light source, is reflective. For this purpose, the rear side can be mirrored, i.e., provided with a layer of reflective material, e.g., mirrored with aluminum, chrome or another suitable metal. The mirror coating can be applied in various ways, e.g., by painting, spraying, vapor deposition, e.g., using a PVD (physical vapor deposition) process or similar. It is also conceivable that a reflective film could be applied to the back of the transparent material, e.g., by gluing, laminating or similar.

It is also conceivable that the rear side of the transparent material is shaped in a special way so that the light reflected on the rear side is reflected back in the direction of the optical axis of the device and can then emerge from the transparent material or optical body. An important aim of the special shaping of the reflective back surface is to direct as much of the reflected light as possible around the semiconductor light source in the light exit direction.

In the present invention, the light path is extended by the optical body or the transparent material. In one embodiment, the light path is traversed twice through the optical body before the light exits the body again. Due to the longer light path in the transparent material, a thin or flat structure of the device for illuminating can be realized, which also has good homogeneity and viewing angle stability, i.e., the illuminated emblem or lettering is still easily recognizable for an observer even from larger viewing angles relative to the longitudinal axis of the vehicle. Further improvements can be achieved by the wide range of design options on the reflective rear side of the transparent material.

Further advantages of the invention are that known standard processes can be used for overmolding the semiconductor light source with the transparent material and for the reflective design of the rear side of the transparent material, which simplifies the manufacture of the device.

It is conceivable that the semiconductor light source may be attached to a carrier film, such as a transparent carrier film, and is electrically contacted via conductor tracks. The conductor tracks may be applied to the carrier foil in a manner known per se. The carrier foil is at least partially transparent in order to allow the light for illuminating the emblem or lettering to escape from the device. For overmolding or overpouring the semiconductor light source, the transparent material is applied to that side of the carrier film to which the semiconductor light source is also attached.

Alternatively, it is proposed that the semiconductor light source without a printed circuit board or carrier film for attaching and contacting the semiconductor light source is arranged and electrically contacted directly on a front side of the transparent material opposite the reflective rear side of the transparent material. This could be achieved, for example, by inserting the semiconductor light source with the electrical leads into an injection mold with the light-emitting surface facing upwards and then overmolding it with the transparent material. After the transparent material has hardened and been removed from the injection mold, the semiconductor light source is arranged directly on the front of the optical body and electrically contacted.

According to an advantageous further development of the invention, it is proposed that a volume scattering layer or a scattering varnish is arranged or applied on a front side of the transparent material opposite the reflective rear side of the transparent material, which is designed to scatter light emerging via the front side of the transparent material and passing through the volume scattering layer or the scattering varnish. This allows particularly good homogeneity of the light emerging from the device to be achieved without hotspots in the area of the light sources. It can also improve lateral visibility from different viewing angles.

The volume scattering layer may include a transparent plastic material or a transparent resin. Scattering elements can be embedded in the volume scattering layer. Alternatively or additionally, the front side of the volume scattering layer can be designed to scatter light, e.g., with a matt finish or similar. If the volume scattering layer is arranged at a distance from the transparent material, the rear side of the volume scattering layer could also be light-scattering, e.g., with a matt finish or similar. Volume scattering materials are commercially available, e.g., satinized PMMA (e.g., Plexiglas®), light-scattering PC (e.g., Makrolon® diffuser from Covestro AG, Leverkusen, Germany) or comparable materials.

If the semiconductor light source is attached to a carrier film, the volume scattering layer or the scattering lacquer can be applied directly to the carrier film (on the side of the carrier film opposite the transparent material). The volume scattering layer may be sprayed on directly. However, it is also possible to design the volume scattering layer as a separate volume scattering plate or scattering film (e.g., Covestro Makrofol®) and to arrange it at a distance from the carrier film.

If a scattering coating is used instead of a volume scattering layer, it may be advantageous to increase the thickness of the optical body or the transparent material compared to the example with the volume scattering layer in order to improve the homogeneity of the light emerging from the device.

The semiconductor light source may be attached directly to a rear side of the volume scattering layer facing the transparent material in the fully assembled state of the device and may be electrically contacted using electrical leads. The semiconductor light source and the electrical leads are then overmolded or overpoured with the transparent material. A printed circuit board or conductor foil, to which the semiconductor light source is attached and contacted, can be dispensed with.

In further embodiments, the reflective rear side can be shaped, at least in certain areas, in such a way that incident light is distributed in a targeted manner. This also promotes the homogeneity of the light emerging from the device. It is also advantageous if the reflective rear side of the transparent material is shaped to deviate from a plane in such a way that a luminance or homogeneity of light emerging via the front side of the transparent material is increased or light emerging via the front side of the transparent material consists of light beams that are parallel to one another.

In this sense, it is proposed, for example, that the reflective rear side of the transparent material is parabolic or paraboloidal in a region on which the light emitted by the semiconductor light source in the main emission direction strikes. The light emitted by the light-emitting surface of the semiconductor light source, after reflection at the reflecting rear side, mainly comprises light beams parallel to each other and preferably also to an optical axis of the device.

According to an alternative embodiment of the invention, it is proposed that the reflective rear side of the transparent material is elliptical or ellipsoidal in a region on which the light emitted by the semiconductor light source in the main emission direction strikes, wherein a light-emitting surface of the semiconductor light source is located in or near a first focal point of the ellipse and a second focal point of the ellipse is located on a rear side of the semiconductor light source facing away from the light-emitting surface of the semiconductor light source. This allows the light emitted by the semiconductor light source to be directed around the semiconductor light source through the light-emitting surface or front side of the transparent material. The light emitted by the light-emitting surface of the semiconductor light source at the first focal point is bundled in the second focal point behind the semiconductor light source after reflection at the reflecting rear side. In this way, shadows cast by the semiconductor light source can be reduced or even completely eliminated. The second focal point can be located in a volume scattering layer, if such a layer is present.

According to another advantageous further development of the invention, it is proposed that the reflective rear side of the transparent material is designed in a deflection area, on which the light emitted by the semiconductor light source in the main emission direction strikes, in such a way that it deflects incident light laterally with respect to the main emission direction of the semiconductor light source. The reflective rear side of the transparent material can be shaped in the deflection area in the manner of a deflection prism in order to deflect the incident light from the semiconductor light source to the side.

In another embodiment, the reflective rear side of the transparent material is formed in an inner part of the deflection area directly around an axis of the semiconductor light source, which runs parallel to the main direction of radiation, in such a way that it deflects incident light to the side, and if the reflective rear side of the transparent material in an outer part of the deflection region surrounding the inner part is designed in such a way that it deflects the laterally deflected light in the direction of a front side of the transparent material opposite the reflective rear side of the transparent material. The light deflected laterally at the inner part of the deflection area is then deflected by the outer part of the deflection area in the direction of the front side of the transparent material (double reflection). The outer part of the deflection area is preferably elliptical or ellipsoidal. Alternatively, the outer part of the deflection area can also be parabolic or paraboloidal.

Instead of double reflection, the light emitted by the semiconductor light source can also be deflected via single reflection in such a way that it is reflected past the semiconductor light source directly onto the front side of the transparent material or a volume scattering layer that may be arranged there. In addition, the reflective rear side in the deflection area or the corresponding reflective surface can have a spherical shape or a free form. Especially at very short distances of the reflecting surface from the semiconductor light source, i.e., at very low thickness of the transparent material, one is in the near field in such a way that a parabolic shape of the reflecting surface is no longer useful due to the then no longer prevailing far field condition and point-like approximation of the semiconductor light source, and it can make sense to modify the surface from the parabolic shape as a free-form surface.

The device according to the invention is suitable for illuminating an emblem or lettering as part of a front panel of a motor vehicle. Here, it may be a requirement that the emblem or lettering should appear chrome-plated in the daytime design and be illuminated in the night-time design. The chrome plating to be illuminated should then be optically semi-transparent. There may also be a requirement for the chrome plating to be radar-transparent, e.g., for a radar-based distance control cruise control system in the vehicle. In this case, appropriate radar-transparent chrome design foils based on indium or a PVD coating can be used. In the present case, “chrome plating” is used as a synonym for “metallizing” or “providing with a metal layer”. The metal layer can consist of or include chromium. Of course, the metal layer can also consist of or comprise another metal, e.g., aluminum or zinc, or even non-metallic materials that simulate the appearance of metal.

The partially transparent chrome plating in the area of the emblem or lettering to be illuminated allows some of the light emitted by the device to pass through, so that the emblem or lettering appears illuminated. Another part of the light emitted by the device is absorbed and yet another part of the light emitted by the device is reflected back towards the device. This reflected light hits the volume scattering layer again, is fanned out backwards there, enters the transparent material and is then reflected again on the reflective rear side of the transparent material and fanned out forwards through the volume scattering layer and partially transmitted through the chrome plating again. A particular advantage here is that the portion of the light reflected back at the chrome plating is not lost, but is used and thus contributes to homogeneity and viewing angle stability.

According to one embodiment of the invention, it is proposed that a light-emitting surface of the device for illuminating the emblem or the lettering is designed to deflect light emitted by the device for illuminating the emblem or the lettering and reflected back to the device by the emblem or the lettering in the direction of an axis of the semiconductor light source which runs parallel to the main direction of emission. This has the advantage that the light reflected back to the device is more likely to hit the deflection area of the reflective rear side of the transparent material again and is thus available again for illuminating the emblem or the lettering.

The problem underlying the present invention is also solved by an illuminated emblem or an illuminated lettering of a motor vehicle of the type mentioned at the beginning. Thus it is proposed that a device according to the invention is provided for illuminating the illuminable emblem or lettering.

According to an advantageous further development, it is proposed that the emblem or the lettering comprises a chromium plating which is partially transparent to light beams and/or radar beams and through which at least a portion of the light emitted by the device for illuminating the emblem or the lettering passes in order to illuminate the emblem or the lettering. In addition to the transmitted portion of the light emitted by the device, another portion of the light is absorbed and yet another portion is reflected back to the device. Due to the special design of the device, however, the reflected light is still available for illuminating the emblem or lettering, which can significantly improve the efficiency of the device and thus also of the entire illuminated emblem or lettering.

It is also advantageous if the distance between the light-emitting surface of the device, i.e., the volume diffusion layer if present, and the chrome plating on the emblem or lettering to be illuminated is as small as possible. However, if the device is a separate supplier part that is only arranged and attached behind the front panel during the production of the vehicle, it will not be possible to prevent a gap between the device and the front panel or the emblem or lettering.

According to one embodiment of the invention, it is proposed that the chrome plating is applied directly to a light-emitting surface of the device for illuminating the emblem or lettering. If a volumetric diffusion layer is present, the light emission surface is formed by a front side of the volumetric diffusion layer. If a volume scattering layer is not present, the light-emitting surface of the device is formed by a front side of the transparent material or the optical body.

The emblem or lettering can be made of a transparent material. To protect against external influences, the chrome plating is preferably applied to the back of the emblem or lettering facing the device for illumination. Alternatively, however, it is also conceivable that the chrome plating is applied to the front of the emblem or lettering facing away from the illuminating device. The chrome plating can have the shape of the emblem or lettering. Alternatively, the chrome plating at least partially defines an outline of the emblem or lettering, whereby the emblem or lettering itself is not chrome-plated.

It is conceivable that the chrome plating of the emblem or lettering is arranged or applied directly on a light-emitting surface of the device for illumination. In this way, a particularly flat illuminated emblem or illuminated lettering can be realized.

The light-emitting surface of the device can be formed by the front side of the transparent material if no volume diffusion layer is present. However, if a volumetric diffusion layer is present, the light-emitting surface of the device can be formed by a front side of the volumetric diffusion layer facing the emblem or lettering to be illuminated.

According to one embodiment of the invention, it is proposed that the chrome plating of the emblem or lettering is arranged at a distance from a light-emitting surface of the device for illuminating the emblem or lettering, and that the light-emitting surface of the device for illuminating the emblem or the lettering illuminates the emblem or the lettering as completely and/or as homogeneously as possible.

The light-emitting surface of the device can, for example, be curved in the direction of the emblem or lettering to be illuminated. The curvature may include a surface area which—in relation to the semiconductor light source—is arranged on the side opposite the reflective rear side of the transparent material. The surface area on the front side of the volume scattering layer and the deflection area on the reflective rear side of the transparent material preferably both extend around an optical axis of the device. The surface area extends in a direction perpendicular to the optical axis of the device at least as far as the deflection area of the reflective rear side of the transparent material. The curvature can have a continuous or steady course. Alternatively, the curvature can also have edges. In the latter case, the curvature has, for example, a flat central area, which is, for example, circular, and an oblique area surrounding it, which is, for example, in the form of a truncated cone. The truncated cone-shaped area can merge into the central area along an edge that is circular, for example. Similarly, the truncated cone-shaped area can merge along another edge, which is also circular, for example, into the remaining part of the light-emitting surface without curvature. The diameter of the circular edge between the frustoconical area and the central area is smaller than the diameter of the other circular edge between the frustoconical area and the remaining part of the light-emitting surface.

The problem underlying the present invention is also solved by an arrangement comprising a front panel arranged in a front region of a motor vehicle and having a plurality of illuminable emblems or lettering arranged next to and/or above one another and a plurality of devices for illuminating the emblems or lettering. More specifically, based on the arrangement of the type mentioned at the beginning, it is proposed that these have a plurality of devices each with a semiconductor light source for illuminating the emblems or lettering, wherein devices according to the invention are provided for illuminating the emblems and lettering.

Advantageously, each of the emblems or lettering is assigned its own device for illuminating the emblem or lettering. This allows targeted illumination of individual emblems or lettering in order to realize certain night designs or animated light effects when locking or unlocking the vehicle. The several illuminated emblems or lettering arranged next to and/or above one another can be illuminated individually or in groups. It is also conceivable to combine the different versions of the device according to the invention with one another.

Several of the devices for illuminating can be arranged next to and/or on top of one another and connected to one another to form a light panel. In a light panel, the transparent layers of the individual devices may be formed as a single transparent layer of the light panel. Similarly, the volume scattering layers of the individual devices may be formed as a single volume scattering layer of the light panel. In the so-called illuminated areas, where the individual devices are arranged in the light panel, a semiconductor light source is arranged in each case, the reflective rear side of the transparent layer and possibly the light-emitting surface of the light panel (e.g., the front side of the volume scattering layer)—as described above—are designed in the desired manner. One or more of the light panels is arranged behind the front panel in the direction of travel in order to specifically illuminate the emblems or lettering on the front panel.

In order to improve pedestrian protection, it is proposed that the transparent material and/or the volume diffusion layer of the light panel is thinner in intermediate areas between the light areas, so that the light panel has greater mechanical flexibility and does not prevent the front panel from giving way in the event of a collision with a pedestrian. The layer thickness does not have to be reduced in every intermediate area; a reduction can also be made only in sections every x (x=2, 3, 4, . . . ) illuminated areas. The layer thickness of the light panel can be reduced in horizontal and vertical directions.

In order to ensure a sufficient material flow in a spray tool, it is advantageous if the material thickness in the intermediate areas is not completely reduced over the entire surface, but if flow webs remain for the spray material.

Reducing the material thickness in the intermediate areas can also be used to reduce or even completely prevent crosstalk between neighboring illuminated areas. In this way, individually illuminated emblems or lettering can be clearly distinguished from non-illuminated neighboring emblems or lettering. Further measures would be, for example, to dispense with a reflective design (e.g., mirroring) of the reverse side of the transparent material in the intermediate areas. Light traveling to the side can then be decoupled there and does not travel on to the next illuminated area. The back of the transparent material can also be frosted or roughened in the intermediate areas in order to prevent light from being reflected further (into a neighboring illuminated area) and to slow down the spread of light through diffuse scattering.

In an alternative embodiment, the deflection area of the reflective rear side of the transparent material can also be convexly curved in the direction of the semiconductor light source. This allows the incident light to be fanned out and a larger illuminated area to be served. In a further embodiment, the deflection area of the reflective rear side of the transparent material can also have a Fresnel lens-like multifaceted structure. Each of the facets can be specifically designed in such a way that light from the semiconductor light source impinging on it is specifically deflected into a predetermined area of the device.

### BRIEF DESCRIPTION OF THE DRAWINGS

Further advantages and embodiments of the present invention are explained in more detail below with reference to the figures. Each of the features shown in the figures can also be essential to the invention on its own, even if this is not expressly mentioned in the following description. Furthermore, several of the features shown-even of different embodiments—can also be combined with one another in any desired manner, even if this is not expressly mentioned in the following description. Thus, other advantages of the invention will be readily appreciated as the same becomes better understood by reference to the following detailed description when considered in connection with the accompanying drawings, wherein:

FIG. 1 shows a first embodiment example of the device according to the invention for illuminating an emblem or lettering;

FIG. 2 shows a second embodiment of the device according to the invention for illuminating an emblem or lettering;

FIG. 3 shows a third embodiment of the device according to the invention for illuminating an emblem or lettering;

FIG. 4 shows a fourth embodiment of the device according to the invention for illuminating an emblem or lettering;

FIG. 5 shows a fifth embodiment example of the device according to the invention for illuminating an emblem or lettering;

FIG. 6 shows a sixth embodiment of the device according to the invention for illuminating an emblem or lettering;

FIG. 7 shows a first embodiment example of the illuminated emblem or lettering according to the invention;

FIG. 8 shows a second embodiment example of the illuminated emblem or lettering according to the invention;

FIG. 9 shows a third embodiment example of the illuminated emblem or lettering according to the invention;

FIG. 10 shows a seventh embodiment of the device according to the invention for illuminating an emblem or lettering;

FIG. 11 shows an eighth embodiment example of the device according to the invention for illuminating an emblem or lettering; and

FIG. 12 shows an arrangement according to the invention comprising a front panel with a plurality of emblems or lettering arranged next to and/or above one another and a light panel with a plurality of devices arranged next to and/or above one another for illuminating the emblems or lettering in a cross-section.

### DETAILED DESCRIPTION OF THE INVENTION

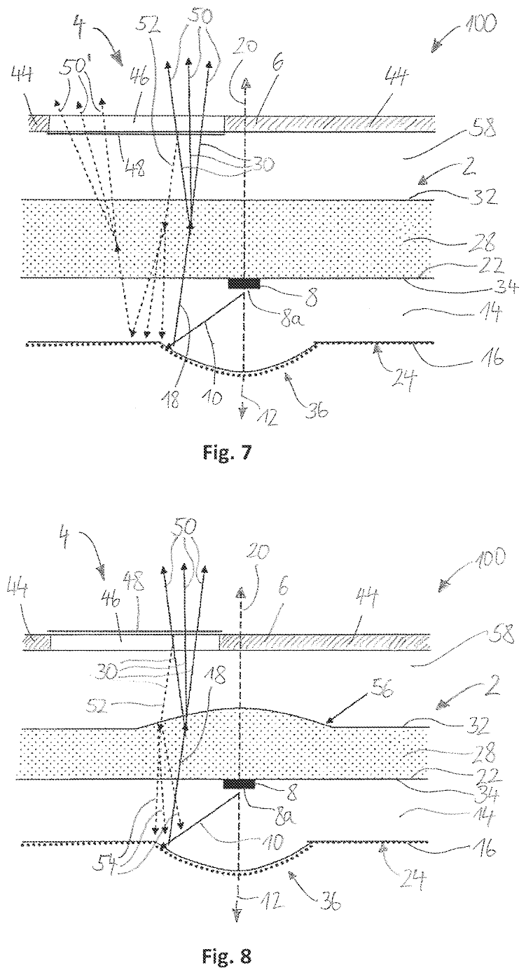

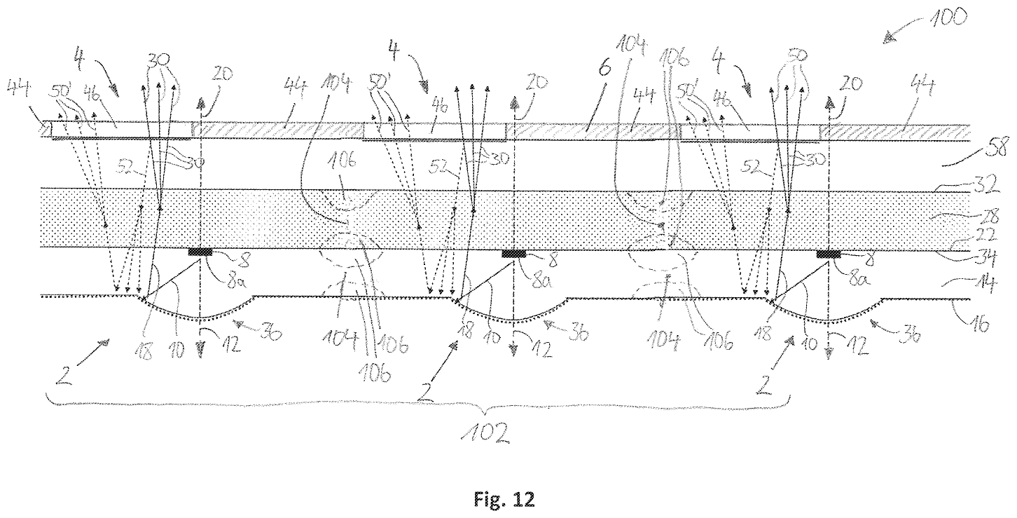

The present invention relates to a device 2 for illuminating an emblem or lettering 4 (see FIGS. 7 to 9). The emblem or lettering 4 is preferably part of a front panel 6 arranged in a front area of a motor vehicle (cf. FIG. 12). The device 2 comprises a semiconductor light source 8 for emitting light 10 in a main emission direction 12. The main emission direction 12 is directed into a 180° half-space, into which the semiconductor light source 8, designed as a Lambertian radiator, emits light 10. The semiconductor light source 8 preferably comprises one or more light emitting diodes (LEDs), preferably so-called top emitting LEDs. However, it is also conceivable that the semiconductor light source 8 comprises one or more OLEDs, laser diodes or similar. The semiconductor light source 8 preferably has a white housing. The light 10 emitted by the semiconductor light source 8 is used to illuminate the emblem or lettering 4.

The semiconductor light source 8 is designed for mounting in the motor vehicle in such a way that the main direction of radiation 12 is directed away from the emblem or lettering 4 to be illuminated (see FIGS. 7 to 9). The semiconductor light source 8 is overmolded or overpoured with a transparent material 14 on its side surrounding the main direction of radiation 12 or on the side facing away from the emblem or lettering 4. A rear side 16 of the transparent material 14 opposite the semiconductor light source 8 is reflective. The reflective rear side 16 is designed to deflect the light 10 emitted by the semiconductor light source 8 to illuminate the emblem or the lettering 4. The light deflected by the rear side 16 is designated by the reference symbol 18.

Roughly speaking, the deflected light 18 is directed in a light emission direction 20 of the device 2. The light emission direction 20 is directed into a 180° half-space into which the light 18 is deflected. The main emission direction 12 of the semi-conductor light source 8 therefore runs approximately opposite to the light emission direction 20 in which light 18 leaves the device 2 to illuminate the emblem or lettering 4. In the example shown in FIG. 1, an optical axis of the device 2 runs congruently with the two directions 12, 20.

One aspect of the invention is the arrangement of the semiconductor light source 8 in the device 2 in such a way that its main emission direction 12 runs in the opposite direction to the intended light exit direction 20 of the device 2.

The illuminated emblem or the illuminated lettering 4 can also be referred to as a light signature. The emblem 4 can, for example, be a symbol or a logo or the like, e.g., of a motor vehicle manufacturer or a vehicle model or an equipment variant of the motor vehicle. However, the emblem 4 can also simply comprise ribs or openings of a radiator grille of a motor vehicle, which are backlit or illuminated at least in certain areas by the device 2 according to the invention. A lettering 4 can be a name of a vehicle manufacturer, a vehicle model, an equipment variant or the like. The lettering 4 can comprise a single or several letters.

The semiconductor light source 8 is therefore arranged and aligned in the device 2 in such a way that its main direction of radiation 12 is directed away from the emblem or lettering 4 to be illuminated when the device 2 is mounted in the motor vehicle. The semiconductor light source 8 emits light 10 in the main direction of radiation 12 via a light-emitting surface 8a. The semiconductor light source 8 is overmolded or overpoured with the transparent material 14 on its side comprising the light-emitting surface 8a, so that a solid transparent optical body is formed there.

Light 10 emitted by the semiconductor light source 8 is coupled into the transparent material 14 or the optical body and propagates therein up to the reflecting rear side 16. The light 10 is then reflected at the rear side 16 and leaves the optical body 14 again as reflected light 18 via a front side 22 opposite the rear side 16, which surrounds the semiconductor light source 8 or extends next to the semiconductor light source 8. A light coupling surface and a light decoupling surface of the optical body 14 are formed by different areas of one and the same surface. The light coupling surface and the light decoupling surface are both arranged opposite the reflective rear side 16.

The transparent material 14 is preferably a clear plastic material, for example, polycarbonate (PC), or a so-called high-flow PC, or polymethyl methacrylate (PMMA) or another suitable transparent plastic material. The transparent material 14 could also consist of a synthetic resin or the like. The thickness of the optical body 14 is only a few millimeters, e.g., 1-3 mm.

The reflective rear side 16 of the transparent material 14 or the optical body can be achieved by mirroring the rear side 16. The mirror coating 24 can be applied in various ways, for example by painting, by spraying, by vapor deposition, for example by means of a PVD (Physical Vapor Deposition) process, by hot stamping or the like. The mirror coating 24 can, for example, consist of or comprise aluminum or chromium or any other metal. It would also be conceivable that a mirrored film is applied to the rear side 16 of the transparent material 14, for example by gluing, laminating or the like.

In the present invention, the light path through the optical body 14 or the transparent material is extended. In particular, the light path through the optical body 14 is traversed twice before the light 18 exits the body 14 again. Due to the longer light path in the transparent material 14, a thin or flat structure of the device 2 for illumination can be realized, which also has good homogeneity and viewing angle stability, i.e., the illuminated emblem or the illuminated lettering 4 is still clearly visible to an observer even from larger viewing angles relative to the longitudinal axis of the vehicle. Further improvements can be achieved by the wide range of design options on the reflective rear side 16 of the transparent material 14.

Further advantages of the invention are that standard processes may be used for overmolding the semiconductor light source 8 with the transparent material 14 and for the reflective design of the rear side 16 of the transparent material 14, which simplifies and reduces the cost of manufacturing the device 2.

In the example shown in FIG. 1, the semiconductor light source 8 is attached to a carrier film 26, such as, for example, a transparent carrier film, and electrically contacted via conductor tracks (not shown). The conductive tracks may be applied to the carrier foil 26 in a manner known per se and connect the semiconductor light source 8 to an energy source, e.g., a vehicle control unit or a vehicle battery. The carrier foil 26 is at least partially transparent in order to allow the light for illuminating the emblem or the lettering 4 to emerge from the device 2. For overmolding or overpouring the semiconductor light source 8, the transparent material 14 is simply applied to the side of the carrier film 26 to which the semiconductor light source 8 is also attached. In this case, the at least partially transparent carrier film 26 forms the light exit surface for the light 18 emitted by the device 2.

Alternatively, it is proposed that the semiconductor light source 8 is arranged and electrically contacted directly on a front side 22 of the transparent material 14 opposite the reflective rear side 16 of the transparent material 14 without a printed circuit board or carrier foil 26 for fastening and contacting the semiconductor light source 8. This could be achieved, for example, by inserting the semi-conductor light source 8 together with the electrical leads into an injection mold with its light-emitting surface facing upwards and then overmolding it with the transparent material 14. After the transparent material 14 has hardened and been removed from the injection mold, the semi-conductor light source 8 is arranged directly on the front side 22 of the transparent material 14 and electrically contacted.

The conductor tracks can be printed onto the carrier film 26 using a printing process. The semiconductor light sources 8 can be bonded to the carrier film 26 in electrical contact with the conductive tracks by means of an adhesive process. The conductive tracks and/or the light sources 8 can then be overmolded with the transparent material 14 in order to fix them in place.

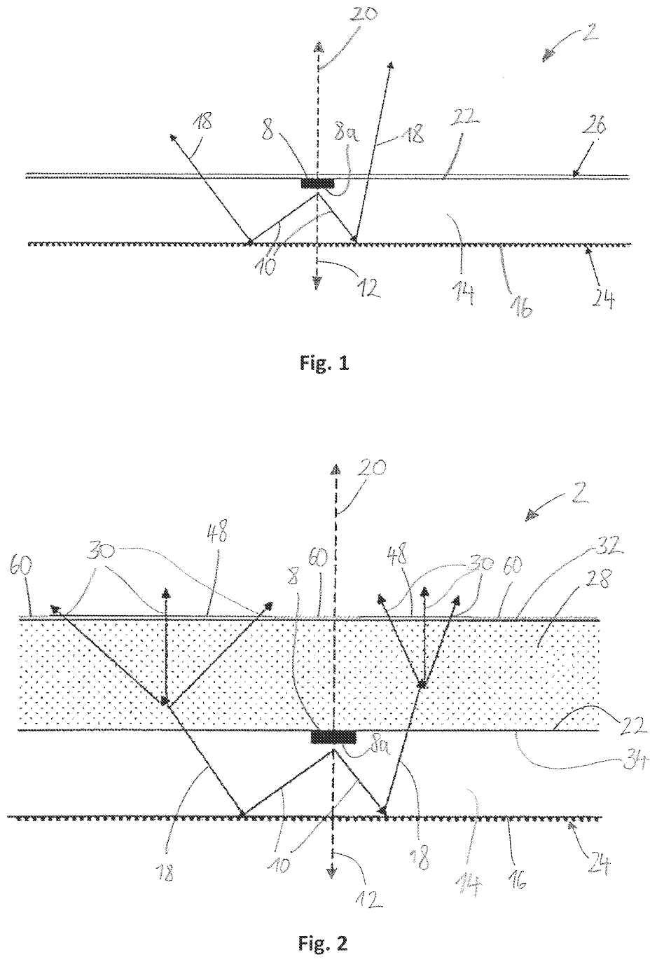

As shown in FIG. 2, a volume scattering layer 28 or a scattering lacquer can be arranged or applied on a front side 22 of the transparent material 14 opposite the reflective rear side 16 of the transparent material 14, which is designed to scatter light 18 emerging via the front side 22 of the transparent material 14 and passing through the volume scattering layer 28 or the scattering lacquer. As a result, a particularly good homogeneity of the light 30 emerging from the device 2 can be achieved without hotspots in the area of the light sources 8. In addition, the lateral visibility from different viewing angles can be improved as a result.

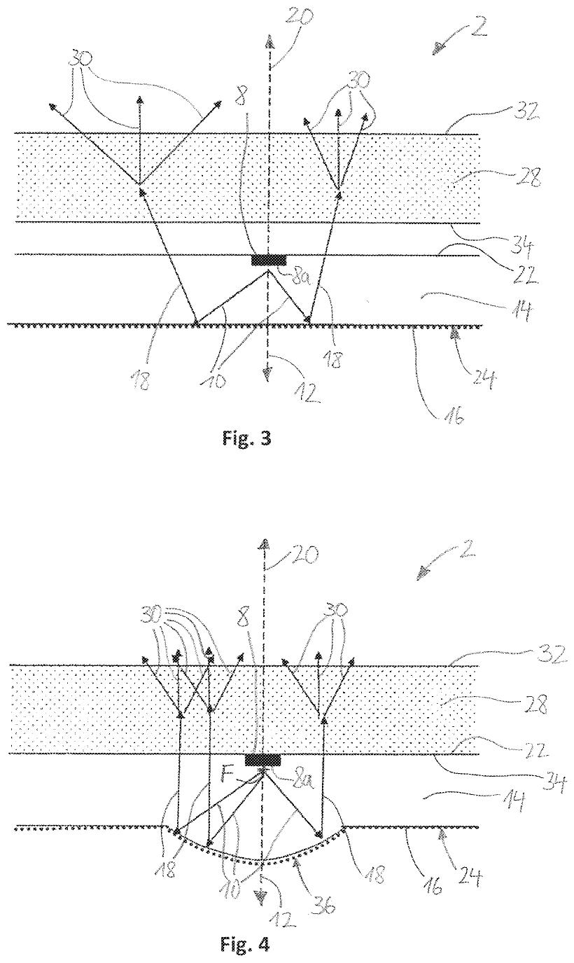

The volume scattering layer 28 may include a transparent plastic material or a transparent resin. Scattering elements can be embedded in the volume scattering layer 28. Alternatively or additionally, a front side 32 of the volume scattering layer 28 can be designed to scatter light, for example with a matt finish or the like. If the volume scattering layer 28 is arranged at a distance from the transparent material 14 (see FIG. 3), a rear side 34 of the volume scattering layer 28 could also be designed to scatter light, e.g., with a matt finish or the like.

If the semiconductor light source 8 is attached to a carrier film 26, the volume scattering layer 28 or the scattering lacquer can be applied directly to the carrier film 26 (on the side of the carrier film 26 opposite the transparent material 14). It is also advantageous if the volume scattering layer 28 is sprayed on directly. However, it may also be possible to design the volume scattering layer 28 as a separate volume scattering plate and to arrange it at a distance from the carrier film 26 or the transparent material 14. It would also be conceivable for the carrier film 26 itself to be a scatter film, e.g., Covestro Makrofol®.

If a scattering coating is used instead of a volume scattering layer 28, it may be advantageous to increase the thickness of the optical body 14 or the transparent material compared to the example with the volume scattering layer 28 in order to improve the homogeneity of the light emerging from the device 2.

As shown in FIG. 2, the semiconductor light source 8 is attached directly to a rear side 34 of the volume scattering layer 28 that faces the transparent material 14 in the fully assembled state of the device 2 and is electrically contacted by electrical leads (not shown). The semiconductor light source 8 and the electrical leads are then overmolded or overpoured with the transparent material 14. In this example, there is no need for a printed circuit board or conductor foil 26 to which the half-conductor light source 8 is attached and contacted.

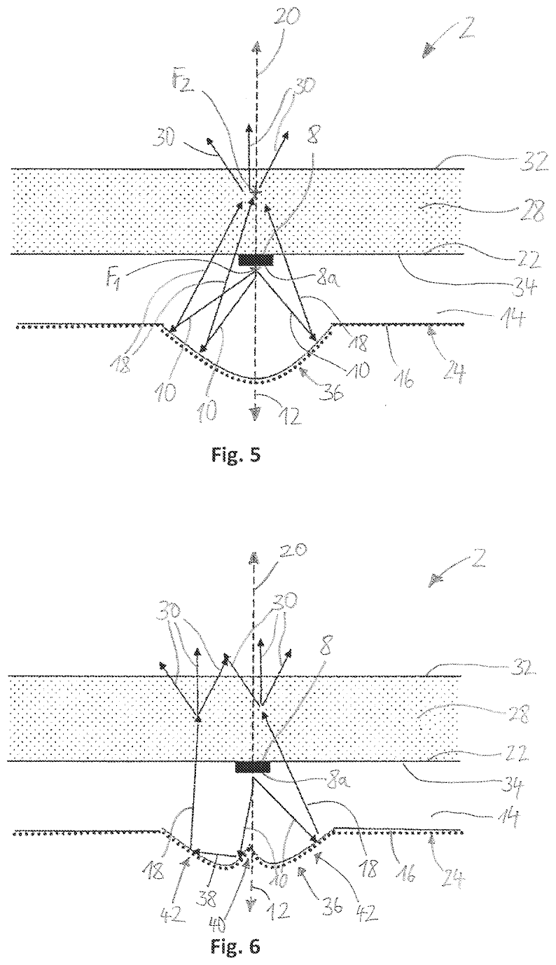

In further embodiments, the reflective rear side 16 can be shaped, at least in certain areas, in such a way that incident light 10 is distributed in a targeted manner. The rear side 16 of the transparent material 14 can be shaped in a particular way so that the light 18 reflected at the rear side 16 is reflected back in the direction of the optical axis 12, 20 of the device 2 and then emerges from the transparent material 14 or optical body. This promotes the homogeneity of the light 18, 30 emerging from the device 2. In one embodiment, the reflecting rear side 16 of the transparent material 14 may be shaped so as to deviate from a plane in such a way that a luminance or a homogeneity of light 18 emerging via the front side 22 of the transparent material 14 is increased (cf. FIG. 5) or the emerging light 18 consists of light beams parallel to one another (cf. FIG. 4).

As shown in FIG. 4, it is proposed, for example, that the reflective rear side 16 of the transparent material 14 is parabolic or paraboloid in a deflection region 36, on which the light 10 emitted by the semiconductor light source 8 in the main emission direction 12 strikes. A focal point F of the parabola is preferably located on or in the vicinity of the light-emitting surface 8a of the semiconductor light source 8. The light 10 emitted by the light-emitting surface 8a of the semiconductor light source 8 comprises, after reflection at the reflecting rear side 16, light beams 18 which are mainly parallel to each other and also to the optical axis 12, 20 of the device 2.

According to an alternative embodiment, which is shown in FIG. 5, it is proposed that the reflective rear side 16 of the transparent material 14 is elliptically or ellipsoidally shaped in a deflection area 36, which is hit by the light 10 emitted by the semiconductor light source 8 in the main emission direction 12. The light-emitting surface 8a of the semiconductor light source 8 is located in or near a first focal point F1 of the ellipse and a second focal point F2 of the ellipse is located on a rear side of the semiconductor light source 8 facing away from the light-emitting surface 8a of the semiconductor light source 8. This allows the light 10 emitted by the semiconductor light source 8 to be deflected around the semiconductor light source 8 through the light-emitting surface or the front side 22 of the transparent material 14. Light 10 can therefore be directed laterally behind the semiconductor light source 8 into the volume scattering layer 28 and fill the shadow cast by the semiconductor light source 8. The light 10 emitted by the light-emitting surface 8a of the semiconductor light source 8 at the first focal point F1 is bundled (light beams 18) behind the semiconductor light source 8 in or near the second focal point F2 after reflection at the reflecting rear side 16. In this way, a shadow cast by the semiconductor light source 8 can be reduced or even completely eliminated. The second focal point F2 can be located in the volume scattering layer 28, if such a layer is present.

In another embodiment of the invention, which is shown in FIG. 6, the reflective rear side 16 of the transparent material 14 is formed in the deflection region 36, on which the light 10 emitted by the semiconductor light source 8 in the main emission direction 12 impinges, in such a way that it deflects incident light 10 laterally with respect to the main emission direction 12 of the semiconductor light source 8 (cf. exemplary light beam 38). The reflective rear side 16 of the transparent material 14 can be shaped in the deflection area 36 in the manner of a deflection prism 40 in order to deflect the incident light of the semiconductor light source 8 to the side.

The reflective rear side 16 of the transparent material 14 in an inner part 40 of the deflection area 36 may be positioned directly around an axis (e.g., the optical axis) of the semiconductor light source. This is particularly advantageous if the reflective rear side 16 of the transparent material 14 is formed in an inner part 40 of the deflection area 36 directly around an axis (e.g., the optical axis) of the semiconductor light source 8, which runs parallel to the main emission direction 12, in such a way that it deflects the incident light 10 laterally, and if the reflective rear side 16 of the transparent material 14 is formed in an outer part 42 of the deflection area 36 surrounding the inner part 40 in such a way that it deflects the incident light 10 laterally, that it deflects the incident light 10, 38 in the direction of a front side 22 of the transparent material 14 opposite the reflective rear side 16 of the transparent material 14. The light 38 deflected laterally at the inner part 40 of the deflection area 36 is then deflected by the outer part 42 of the deflection area 36 in the direction of the front side 22 of the transparent material 14 (double reflection). The outer part of the deflection area 36 may be elliptical or ellipsoidal in shape. Alternatively, the outer part of the deflection area can also be parabolic or paraboloid.

Instead of double reflection (left side of FIG. 6), the light 10 emitted by the semiconductor light source 8 can also be deflected by single reflection in such a way that it is reflected past the semiconductor light source 8 directly onto the front side 22 of the transparent material 14 or into a volume scattering layer 28 that may be arranged there (right side of FIG. 6).

In addition, the reflective rear side 16 in the deflection area 36 or the corresponding reflective surface 16 could have a spherical shape or a free form. In particular at very short distances of the reflective surface 16 from the semiconductor light source 8, i.e., with very low thickness of the transparent material 14, the near field is such that a parabolic shape of the reflective surface 16 no longer makes sense due to the then no longer prevailing far field condition and point-like approximation of the semiconductor light source 8, and it may make sense to modify the surface from the parabolic shape as a free-form surface.

The device 2 according to the invention is suitable for illuminating an emblem or lettering 4 as part of a front panel 6 of a motor vehicle. In one embodiment, as shown for example in FIG. 7, the front panel 6 can consist of a transparent material, in particular a plastic material, which is made opaque in areas 44 outside the emblems or lettering 4, for example using an opaque coating, so that the emblems or lettering 4 to be illuminated are formed by the remaining transparent areas 46. In another embodiment, it would also be possible to manufacture the front panel 6 from an opaque material, in particular a plastic material, whereby the emblems or lettering are formed as recesses in the opaque material. The cut-outs can be made during the manufacture of the front panel 6 or cut out afterwards. A transparent material can be inserted into the recesses so that the front panel 6 is closed. Other designs of the front panel 6 with the emblems or lettering 4 are also conceivable.

It may be a requirement that the emblem or lettering 4 should appear chrome-plated in the day design and be illuminated in the night design. This can be achieved by an optically partially transparent chrome plating 48, which is applied to the inside (see FIG. 7) or the outside (see FIG. 8) of the transparent areas 46. There may also be a requirement for the chrome plating 48 to be radar-transparent, e.g., for a radar-supported distance control cruise control system of the vehicle whose radar beams pass through the front panel 6. In this case, corresponding radar-transmitting chrome design foils based on indium or a PVD coating can be used as chrome plating 48. In the present application, “chrome plating” is used as a synonym for “metallizing” or “providing with a metal layer”. The metal layer can consist of or include chromium. Of course, the metal layer can also consist of or include another metal, e.g., aluminum or zinc as well as non-metallic materials that simulate the appearance of metal.

As shown in FIG. 7, the partially transparent chrome plating 48 allows part 50 of the light 30 emitted by the device 2 to pass through in the area of the emblem or lettering 4 to be illuminated, so that the emblem or lettering 4 appears illuminated. Another part of the light 30 emitted by the device 2 is absorbed and yet another part 52 of the emitted light 30 is reflected back towards the device 2. This reflected light 52 strikes the volume scattering layer 28 again, is fanned out backwards there, enters the transparent material 14 and is then reflected again at the reflective rear side 16 of the transparent material 14 and fanned out forwards through the volume scattering layer 28 and transmitted again in part through the chrome plating 48 (portion 50′ of the light). It is advantageous here that the portion 52 of the light 30 reflected back at the chrome plating 48 is not lost, but is used to illuminate the emblem or lettering 4 and thus contributes to homogeneity and viewing angle stability.

In the embodiment of FIG. 8, a light-emitting surface of the device 2 is designed to deflect light 52 emitted by the device 2 to illuminate the emblem or the lettering 4 and reflected by the emblem or the lettering 4 or the chrome plating 48 back to the device 2 in the direction of an axis of the semiconductor light source 8, which runs parallel to the main emission direction 12 (cf. light beams 54). The light exit surface of the device 2 may be formed by the front surface 32 of the volume scattering layer 28, if such a volume scattering layer 28 is present, or otherwise may be formed by the front surface 22 of the optical body 14. This configuration has the advantage that the light 52 reflected back to the device 2 is more likely to hit the deflection area 36 of the reflective rear side 16 of the transparent material 14 again and is thus available again for illuminating the emblem or the lettering 4.

This can be achieved, for example, by the light-emitting surface 32, 22 of the device 2 having a lens-like curvature 56 in the direction of the front panel 6 (see FIG. 8). The curvature 56 comprises the optical axis 12, 20 extending through the deflection area 36. The curvature 56 on the front surface 22, 32 of the device 2 and the deflection area 36 on the reflective rear surface 16 of the transparent material 14 may both extend around the optical axis 12, 20 of the device 2. In a plan view parallel to the optical axis 12, 20, the curvature 56 may extend in a surface area that is larger than the deflection area 36. Other embodiments are also conceivable, however, for example a Fresnel lens-like multifaceted structure. In FIG. 8, the curvature 56 has a continuous or steady course.

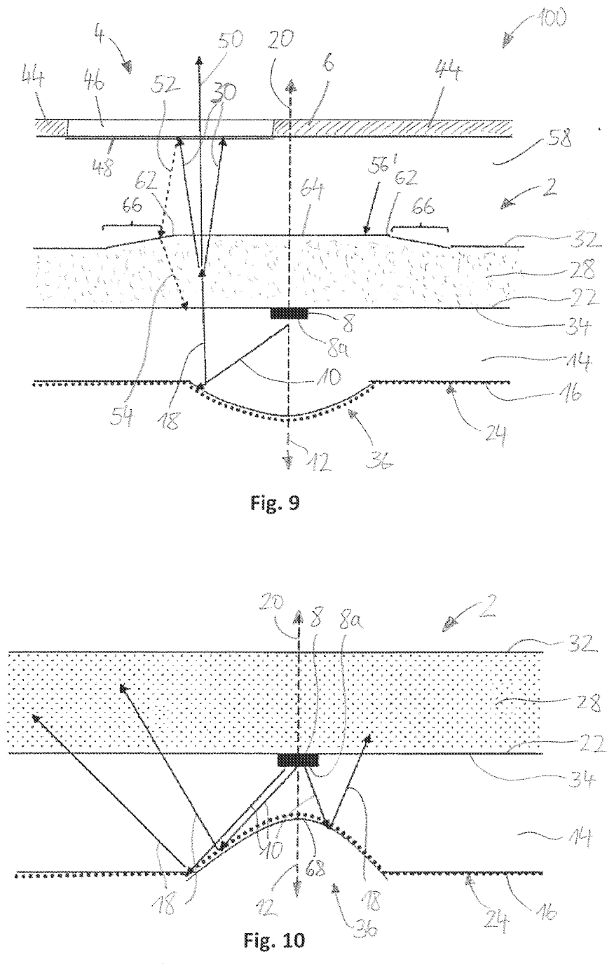

Alternatively, the curvature 56′ can also be designed as shown in FIG. 9. Viewed in cross-section, the curvature 56′ comprises a flat plateau surface 64 extending perpendicular to the optical axis 12, 20, which is connected to the remaining flat light exit surface 22, 32 of the device 2 via inclined flat edge surfaces 66. Edges 62 may be formed at the transition between the plateau surface 64 and the edge surfaces 66. In a plan view, the plateau surface 64 preferably has a round shape and the edge surfaces 66 form a truncated cone. In a plan view, the plateau surface 64 is may be larger than the deflection area 36 of the reflective rear side 16 of the transparent material 14. Light 52 that has migrated laterally is refracted back into the deflection area 36 by the edge surfaces 66.

It is also advantageous if the distance 58 between the light-emitting surface 32, 22 of the device 2 and the chrome plating 48 on the emblem or lettering 4 to be illuminated is as small as possible. This could be achieved, for example, by applying the chrome plating 48 (e.g., a chrome design foil) directly to the light-emitting surface 32, 22 of the device 2 (see FIG. 2), e.g., by lamination. The areas between the chrome plating 48 of adjacent emblems or lettering 4 can be provided with an opaque coating 60. In a top view, the shape of the chrome plating 48 corresponds to the emblems or lettering 4 to be illuminated. This allows a flat illuminated emblem or illuminated lettering 4 to be realized. In this case, the front panel 6 or the emblem to be illuminated or the lettering 4 to be illuminated would therefore be designed as an integral part.

However, if the device 2 is a separate supplier part that is only arranged and attached behind the front panel 6 during the production of the motor vehicle, it will not be possible to prevent a gap 58 between the device 2 and the front panel 6 or the emblem or lettering 4, as shown, for example, in FIGS. 7 to 9, for example.

FIG. 12 shows an arrangement according to the invention comprising a front panel 6 arranged in a front area of a motor vehicle with several illuminable emblems or lettering 4 arranged next to and/or above one another and several devices 2 each with a semiconductor light source 8 for illuminating the emblems or lettering 4. The arrangement 100 comprises several of the devices 2 and emblems or lettering 4 of FIG. 7. The description relating to the embodiment example of FIG. 7 also apply correspondingly to the arrangement 100 according to FIG. 12.

Although FIG. 12 shows only three of the devices 2 and emblems or lettering 4, the arrangement 100 can also have fewer or more than three. The devices 2 can be combined to form a common light panel 102. In this case, the optical bodies 14 of the individual devices 2 can be combined to form a single optical body 14. Similarly, the volume scattering layers 28 of the individual devices 2 can be combined to form a single volume scattering layer 28. One or more of the light panels 102 is arranged behind the front panel 6 in the direction of travel in order to specifically illuminate the emblems or lettering 4 of the front panel 6.

Although a separate front panel 6 is shown in FIG. 12, it would also be conceivable to form the front panel 6 or the emblems or lettering 4 to be illuminated and the light panel 102 as an integral part. This could be achieved, for example, by applying a chrome plating 48 directly to the front side 32 of the volume diffusion layer 28, e.g., by laminating a chrome design film to the front side 32. In this case, the entire component can then be coated again on the front side with a particularly resistant coating, e.g., a surface protection lacquer, a so-called hardcoat lacquer, or preferably with PU flooding, in order to protect the chrome design foil.

Although FIG. 12 shows the same number of devices 2 and emblems or lettering 4, the number of devices 2 and emblems or lettering 4 can also differ from one another. However, each of the emblems or lettering 4 may be assigned its own device 2 for illuminating the emblem or lettering 4. In one embodiment, the several illuminated emblems or lettering 4 may be arranged next to and/or above one another can be illuminated individually or in groups.

Each device 2 forms an illuminated area. In order to improve pedestrian protection, it is proposed that the transparent material 14 and/or the volume scattering layer 28 of the illuminated panel 102 be thinner in intermediate areas 104 between the illuminated areas 2. This is indicated in FIG. 12 by dashed areas 106, which can be removed or omitted. Only one or more of the areas 106 can be removed or omitted. This gives the light panel 102 greater mechanical flexibility, particularly in the direction of travel, and does not block the front panel 6 from yielding in the direction of the light panel 102 in the event of a collision with a pedestrian. The layer thickness does not have to be reduced in every intermediate area 104; a reduction can also be made only in sections every x (x=2, 3, 4, . . . ) illuminated areas 2. The layer thickness of the light panel can be reduced in horizontal and vertical directions.

In order to ensure a sufficient material flow in a spray tool, it is advantageous if the material thickness in the intermediate areas 104 is not completely reduced over the entire surface, but if flow webs remain for the spray material.

The reduction of the material thickness in the intermediate areas 104 can also be used to reduce or even completely prevent crosstalk of light between neighboring light areas 2. In this way, individually illuminated emblems or lettering 4 can be clearly demarcated from non-illuminated neighboring emblems or lettering 4. Further measures to prevent crosstalk may include, for example, to dispense with a reflective design (e.g., mirroring) of the rear side 16 of the transparent material 14 in the intermediate areas 104. Light traveling to the side can then be decoupled there and does not travel on to the next illuminated area 2. The rear side 16 of the transparent material 14 can also be frosted or roughened in the intermediate areas 104 in order to prevent light from being reflected into a neighboring illuminated area 2 and to slow down the spread of light by diffuse scattering.

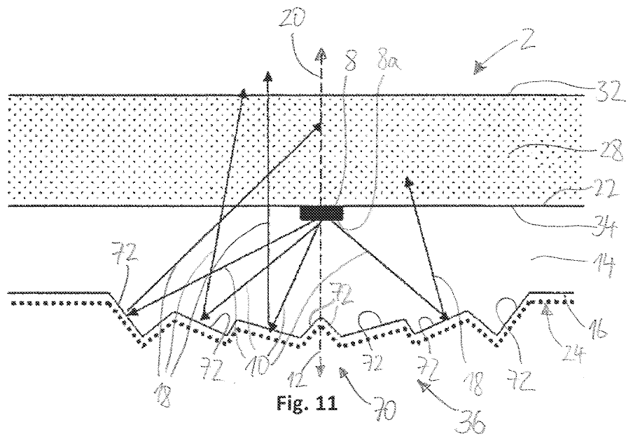

In an alternative embodiment, which is shown in FIG. 10, the deflection area 36 of the reflective rear side 16 of the transparent material 14 can also have a convex curvature 68 directed towards the semiconductor light source 8. This allows the incident light 10 to be fanned out and a larger illuminated area to be served. In a further embodiment, shown in FIG. 11, the deflection area 36 of the reflective rear side 16 of the transparent material 14 can also have a Fresnel lens-like multi-facet structure 70. Each of the facets 72 can be specifically designed in such a way that light 10 from the semiconductor light source 8 impinging on it is specifically deflected into a predetermined area of the device 2. Preferably, the light 10 is directed past the semiconductor light source 8 in the light exit direction 20 of the device 2.

In one embodiment, the conductor tracks for contacting the semiconductor light source 8 are laid in such a way that the area covered by them in the illuminated area 2 is minimized. This can be achieved, for example, by the conductor tracks having a straight course. Furthermore, the conductor tracks may be routed in a ring around the illuminated areas 2 outside the illuminated areas 2.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A device for illuminating an emblem or lettering of a motor vehicle, the emblem or the lettering to be illuminated preferably as part of a front panel arranged in a front region of the motor vehicle, the device comprising a semiconductor light source for emitting light in a main emission direction, wherein light leaving the device in a light emission direction is used to illuminate the emblem or lettering,
wherein the semiconductor light source is configured to be mounted in the device in such a way that the main emission direction of the semiconductor light source is aligned in a direction opposite to the light emission direction of the device,
a transparent material is applied to the semiconductor light source on its side encompassing the main emission direction by overmolding or overpouring, and
a rear side of the transparent material opposite the semiconductor light source is designed to be reflective,
wherein the reflective rear side is configured to deflect light emitted by the semiconductor light source into the light emission direction for illuminating the emblem or lettering.

2. The device as set forth in claim 1, wherein the semiconductor light source is mounted on a carrier foil, in particular on a transparent carrier foil, and is electrically contacted via conductor tracks, wherein the conductor tracks are preferably printed on the carrier foil from a conductive material.

3. The device as set forth in claim 1, wherein the semiconductor light source is arranged and electrically contacted directly on a front side of the transparent material opposite the reflective rear side of the transparent material, without a printed circuit board or a carrier foil for fixing and contacting the semiconductor light source.

4. The device as set forth in claim 1, wherein a volume scattering layer or a scattering lacquer is arranged or applied on a front side of the transparent material opposite the reflective rear side of the transparent material, which volume scattering layer or scattering lacquer is configured to scatter light emerging via the front side of the transparent material and passing through the volume scattering layer or the scattering lacquer.

5. The device as set forth in claim 3, wherein the semiconductor light source is fastened directly to a rear side of the volume scattering layer facing the transparent material in the fully assembled state of the device and is electrically contacted by electrical leads, and the transparent material is subsequently applied to the semiconductor light source and the electrical leads by overmolding or overpouring.

6. The device as set forth in claim 1, wherein the reflective rear side of the transparent material is shaped deviating from the form of a plane such that a luminance or a homogeneity of light emerging via the front side of the transparent material is increased or light emerging via the front side of the transparent material consists of light beams parallel to each other.

7. The device as set forth in claim 1, wherein the reflective rear side of the transparent material is formed parabolic or paraboloid in a deflection region which is hit by the light emitted by the semiconductor light source in the main emission direction.

8. The device as set forth in claim 1, wherein the reflective rear side of the transparent material is elliptically or ellipsoidally shaped in a deflection region which is hit by the light emitted by the semiconductor light source in the main emission direction, wherein a light-emitting surface of the semiconductor light source is located in or near a first focal point of an ellipse of the elliptically or ellipsoidally shaped reflective rear side and a second focal point of the ellipse is located on a rear side of the semiconductor light source facing away from the light-emitting surface of the semiconductor light source.

9. The device as set forth in claim 1, wherein the reflective rear side of the transparent material in a deflection region, which is hit by the light emitted by the semiconductor light source in the main emission direction, is designed in such a way that it deflects incident light laterally with respect to the main emission direction of the semiconductor light source.

10. The device as set forth in claim 9, wherein the reflective rear side of the transparent material is designed in an inner part of the deflection region directly surrounding an axis of the semiconductor light source, which runs parallel to the main emission direction, in such a way that it deflects incident light laterally, and wherein the reflecting rear side of the transparent material is designed in an outer part of the deflection region surrounding the inner part in such a way that it deflects the laterally deflected light in the direction of a front side of the transparent material opposite the reflective rear side of the transparent material.

11. The device as set forth in claim 1, wherein a light-emitting surface of the device for illuminating the emblem or lettering is designed to deflect light, emitted by the device for illuminating the emblem or lettering and reflected by the emblem or lettering, back to the device in a direction towards an axis of the semiconductor light source, which runs parallel to the main direction of emission.

12. An illuminated emblem or illuminated lettering of a motor vehicle, preferably forming part of a front panel arranged in a front region of the motor vehicle, comprising an illuminable emblem or an illuminable lettering and a device having a semiconductor light source for illuminating the illuminable emblem or lettering,
wherein the device for illuminating the illuminable emblem or lettering is designed as set forth in claim 1.

13. The illuminated emblem or lettering as set forth in claim 12, wherein the illuminable emblem or the lettering comprises a chrome plating which is partially transparent to light beams and/or radar beams and through which at least a part of the light emitted by the device for illuminating the emblem or the lettering passes in order to illuminate the emblem or the lettering.

14. The illuminated emblem or lettering as set forth in claim 13, wherein the chrome plating is applied directly to a light-emitting surface of the device for illuminating the emblem or lettering.

15. The illuminated emblem or lettering as set forth in claim 13, wherein the chrome plating is arranged at a distance from a light-emitting surface of the device for illuminating the emblem or lettering, wherein the light-emitting surface of the device for illuminating the emblem or lettering is preferably designed to illuminate the emblem or lettering as completely and/or as homogeneously as possible.

16. An arrangement comprising a front panel arranged in a front region of a motor vehicle and having a plurality of illuminable emblems or lettering arranged next to and/or above one another, and a plurality of devices each having a semiconductor light source for illuminating the emblems or lettering,
wherein the devices for illuminating the emblems or lettering are designed as set forth in claim 1.

17. The arrangement as set forth in claim 16, wherein each of the emblems or lettering is assigned its own device for illuminating the emblem or lettering.

18. The arrangement as set forth in claim 16, wherein the emblems or lettering can be illuminated individually or in groups.

19. The arrangement as set forth in claim 16, wherein the transparent material and/or the volume scattering layer is designed to be thinner in intermediate areas between individual devices than in other areas.
